(19) United States
(12) Patent Application Publication
(10) Pub. No.: US 2026/0296843 A1
(43) Pub. Date: Oct. 1, 2026

(54) Method for installing a heavy load in a supporting structure and a system built according to the method

(71) Applicant: DSD HEAVY LIFT AG, Oberageri (CH)

(72) Inventor: Claude Camille Pirson, Alosen (CH)

(73) Assignee: DSD HEAVY LIFT AG, Oberageri (CH)

(21) Appl. No.: 19/478,626

(22) PCT Filed: Apr. 23, 2024
(86) PCT No.: PCT/EP2024/061129

§ 371 Date: Oct. 24, 2025

(30) Foreign Application Priority Data
Apr. 28, 2023 (CH) 000460/2023
Mar. 1, 2024 (CH) 000232/2024

(51) Int. Cl. B66C 17/26; B66C 13/08

(52) U.S. Cl. CPC B66C 17/26; B66C 13/08

(57) ABSTRACT

In a method for installing a heavy load in a supporting structure, the supporting structure (15) consists of supporting elements which can preferably be assembled one above the other and is assembled at least by a crane system A lifting system (25), preferably a strand jack system, is mounted in the supporting structure (15), the heavy load to be installed is then connected to several longitudinal elements (34) of the lifting system (25) and conveyed upwards in this supporting structure (15) and the heavy load is fixed in the supporting structure, in particular in the operating position. The lifting system (25), mounted at a certain height in the supporting structure (15), is provided with a cavity (44′) on the inside through which the heavy load can be lifted in the supporting structure, up to the operating position and fixed there. With this method, the heavy load, which is in particular a reactor for metal extraction, can be guided to the supporting structure in the assembled stale despite the enormously high weight load, which can vary, and safely pulled up into said supporting structure into the operating position.

The invention relates to a method for installing a heavy load in a supporting structure, in which the supporting structure consists of supporting elements which can preferably be assembled one above the other and is assembled at least by a crane system, according to the preamble of claim 1 or claim 8.

In order to minimize environmentally harmful emissions in metal production, such as also in the iron and steel industries, sustainably in the long term, efforts are being made to introduce new technologies in which CO2 waste gases can be practically eliminated. Thus, occasionally when extracting iron from ores, instead of conventional blast furnaces which work with coking coal as energy source, new methods in production processes are being sought in which a direct reduction can take place on the basis of renewable energies. Advantageously, natural gas or better still hydrogen, through which the reduction process is made possible to the greatest possible extent with CO₂ waste gases, is suitable for this.

For this purpose, new systems are being built which, as with blast furnaces, each have a complex reactor container as a heavy load in a supporting structure or the like. The system for operation with the complex reactor container is designed such that supplying iron ore and other constituents as well as energy into the reactor can be ensured optimally, and moreover, cooling of the reactor walls is ensured.

Such complex reactor containers can each have unladen weights of over 1000 tonnes and are therefore usually assembled in the supporting structure from a plurality of individual parts at the operating location, and in so doing are simultaneously mounted in this supporting structure. This procedure is expensive and linked to correspondingly high costs due to the use of large cranes for erecting the supporting structure, and assembly and installation of the reactor. Moreover, the reactor has to be constructed such that it can be assembled in the supporting structure or the like taking into account conditions, which leads to it not being able to be designed optimally.

The object of the invention is to create a method for installing a heavy load in a supporting structure, by means of which such an installation in the operating state in the supporting structure can be achieved more securely, in a more time-saving and more cost-effective manner, and the heavy load can be designed such that limitations, as with an assembly in the supporting structure, need not be taken into account.

According to the invention, this object is achieved by the features of the method according to claim 1 or the system according to claim 8.

In the method according to the invention, a lifting system is mounted in the supporting structure, the heavy load to be installed is then connected to several longitudinal elements of the lifting system and conveyed upwards in this supporting structure and the heavy load is fixed in the supporting structure, in particular in the operating position.

The heavy load to be conveyed is in particular a reactor for metal extraction in at least approximately operation-ready finished state. The heavy load is moved by transport means in horizontal direction as far as the supporting structure.

With this method according to the invention, this heavy load, which in particular is a reactor for metal extraction, can be guided in assembled state up to the supporting structure and securely pulled up into operating position in this supporting structure in spite of the enormously heavy weight load which can vary.

The heavy load, which can be pivoted upwards from a horizontal position by the longitudinal elements of the lifting system, articulated to same at the top, is consequently pulled up by longitudinal elements of the lifting system, which are, or are to be, connected in the central region of the heavy load, over a partial height range through the cavity of the latter up as far as into the operating position.

Very advantageously, the lifting system is mounted in the supporting structure such that it can be removed from this supporting structure after the system has finished being installed, and can be re-installed therein when preferably the heavy load has to be dismounted from the supporting structure and/or replaced.

Expediently, the lifting system has cross-members mounted in the supporting structure and lifting units attached to these, wherein these cross-members and lifting units can be removed preferably after the system has finished being installed, in which the cross-members can be conveyed laterally away from the supporting structure or correspondingly laterally inserted and fixed after being re-installed.

In an advantageous development of the system, the lifting system consists of a base frame forming a cavity supported in the supporting structure, cross-members held thereon and the several lifting units attached thereto, in which the longitudinal elements respectively extend through a cross-member and the base frame.

The invention provides that the longitudinal elements of the lifting system can be connected at connection points on the support frame below the hull in its central region at the reactor, in order that the reactor can be guided through up to its end position and mounted in the supporting structure by the lifting system.

In the lifting system mounted in the supporting structure, preferably a strand-jack system is used as lifting unit, provided respectively with a hydraulic or pneumatic piston/cylinder unit and at the upper end of the piston or at the lower end of the cylinder respectively with a clamping device with radially adjustable clamps for alternately holding or releasing the longitudinal element(s), which element(s) is (are) guided through inside a central through opening of the piston/cylinder unit.

The invention, and further advantages of same, are explained in more detail below using exemplary embodiments with reference to the drawings. These show:

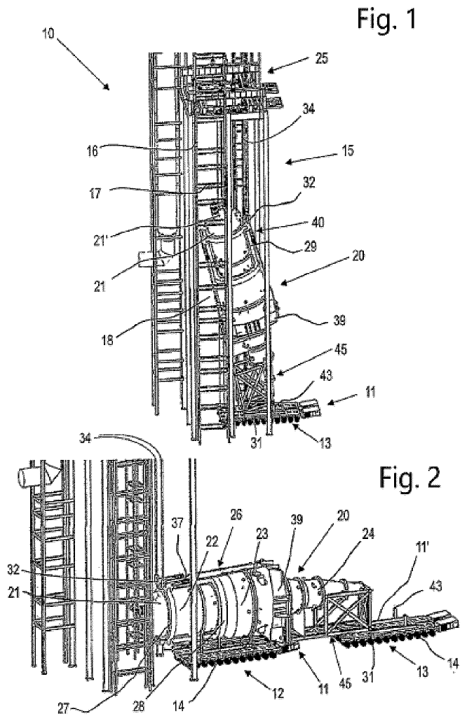

FIG. 1 is a perspective lateral view of the lower part of the system according to the invention with a heavy load designed as a reactor, in a supporting structure, as well as a transport means supporting the heavy load and, above the heavy load, the lifting system in the supporting structure;

FIG. 2 is a perspective lateral view of the system according to FIG. 1 in the lying transport position of the reactor on the shown transport means, in which this reactor is pushed, with its front head part, into the indicated supporting structure;

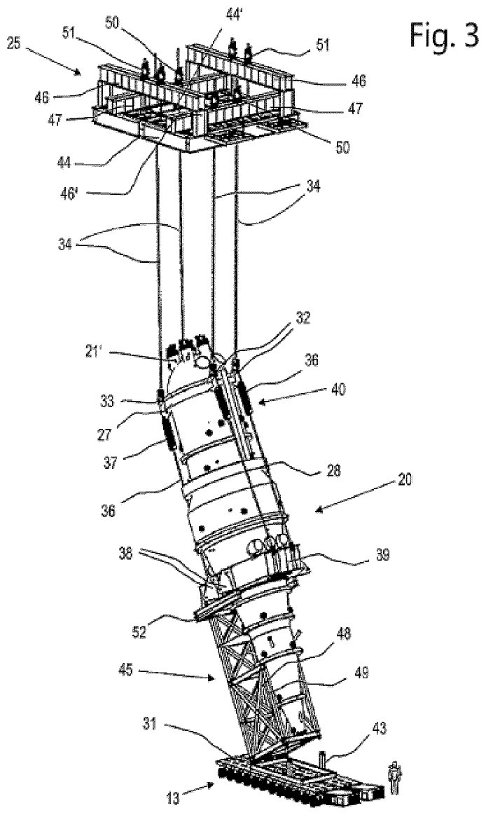

FIG. 3 is a perspective lateral view of the reactor and of the lifting system according to FIG. 1, wherein the reactor is shown in the lifted up position on the transport means standing without the supporting structure; and

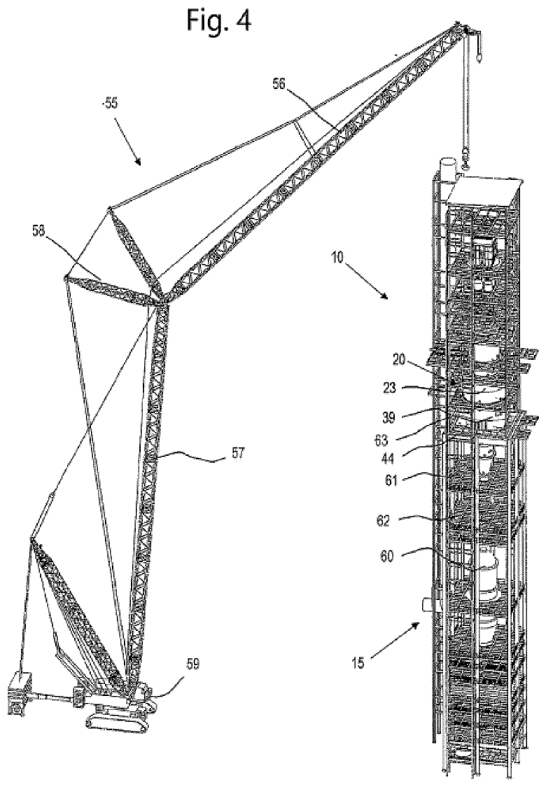

FIG. 4 is a perspective view of the finished system according to FIG. 1 with the reactor installed in the supporting structure and a cooler container as well as a crane system adjacent to the system;

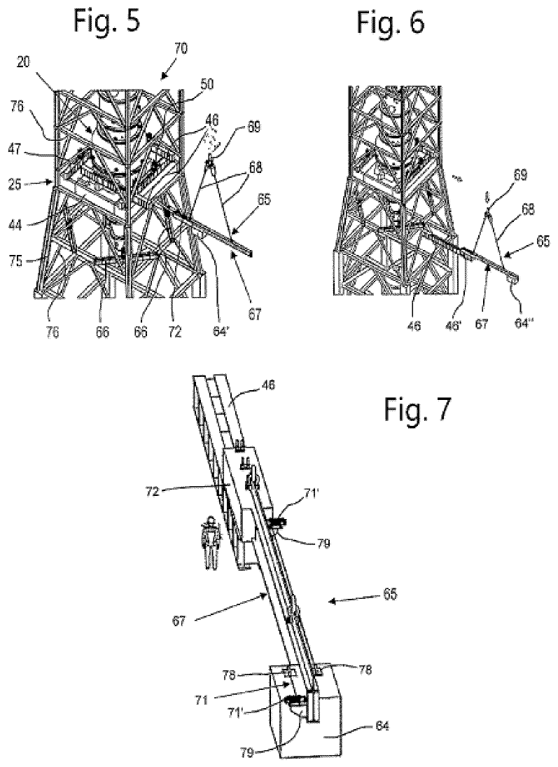

FIG. 5 is a perspective lateral view of a variant of a supporting structure shown in part, with the installed reactor and lifting system as well as a lifting device;

FIG. 6 is a perspective lateral view of the partially shown supporting structure as well as the lifting device to be dismounted from a cross-member according to FIG. 5; and

FIG. 7 is a perspective top view of the lifting device according to FIG. 5.

FIG. 1 to FIG. 4 show a system 10 illustrated in principle, with a supporting structure 15 and a heavy load as a reactor 20, to be installed in the structure. This supporting structure 15 consists of a grid-like structure as a basic framework with longitudinal elements and transverse elements 16, 17, wherein it is developed on the inside with a cavity 18 and, due to the required height, as a tower. As mentioned, this is represented only in principle. In any case, it has to be provided with sufficiently strong statics for it to be able to absorb these enormous load forces of the heavy load to be mounted. This supporting structure can be designed differently, depending on conditions and requirements, and can be placed, free-standing, in an area of the factory or the like, or as part of a building with a number of floors or the like.

In the method according to the invention, the heavy load to be conveyed is in particular a reactor 20 for metal extraction in at least approximately operation-ready finished state. This reactor 20 as heavy load is moved, in horizontal direction, as far as or partially into the cavity 18 of the supporting structure 15 by a transport means 11, preferably by a SPMT (self-propelled modular transporter), and is pivoted upwards by a lifting system 25, preferably a strand-jack system, mounted in the supporting structure 15, and pulled up and mounted in the supporting structure 15 as far as its operating position. For upwards pivoting into its approximately upright position, the reactor 20 is housed tiltable at the bottom on the transport means 11 and is pivoted about an articulated connection 31.

The invention is characterized in that, with same, in particular such a reactor 20 can be lifted up, in approximately operation-ready finished state, with an unladen weight of more than 1000 tonnes, in a completely novel manner into a required operating position, to a height of for example 80 m. The reactor is preferably one of those by means of which iron ore is processed by direct reduction with renewable energies and from this, iron is obtained, predominantly for the metal industry, in a multi-stage process.

The reactor 20 developed as a container consists, with its outer shape similar to a torpedo, of a front stepped cylindrical section 22 with a head part 21 with several upwards-projecting connecting supports 21′, not explained in more detail, as well as of a hull 23, enlarged in diameter, with a support frame 39 and a cone-shaped lower part 24 which runs approximately to a tip.

A reinforcement device 26 is mounted to the outer sheath of the cylindrical section 22, which device is installed either fixedly or advantageously capable of being removed. It has two reinforcement elements 27, 28, separate from one another, which can be mounted as rings, capable of being removed, at the outer periphery of the reactor 20 and are mounted to one another by at least one web 29. At the front reinforcement element 27, advantageously on opposite sides, two spatially separate connection points 32, 33 are attached protruding, which can be connected to longitudinal elements 34 of the lifting system 25. When pivoting the reactor 20 upwards, only the two connection points 32 have to be coupled with longitudinal elements 34 on the top side, whereas the opposite connection points 33 are connected to such longitudinal elements 34 only after pivoting to raise the reactor 20 up, with the result that this lifting system 25 is able to lift the reactor 20 vertically up to its end position.

Moreover, an adjustable clamping device 40, not explained in more detail, is assigned to the respective reinforcement elements 27, 28, on the outside of the reactor, which elements respectively consist of a longitudinal clamping element 37 and a tie 36, coupled to same, creating a selectable tensile strength in its longitudinal direction. Each of the four connection points 32, 33 grips such a clamping element 37 with one end, which extends parallel to the axial direction of the reactor, and is held at the other end at the annular support frame 39. Coordinating tensile forces can be generated on the front reinforcement element 27 in opposite direction to the lifting force of the longitudinal elements 34 by these clamping devices 40, in order to counteract this lifting force at the reinforcement element 27.

This illustrated reactor 20 can self-evidently be shaped in a different way from that shown. For example, firstly the hull 23 and the upper cylindrical section 22 can also be mounted with the head part 21 and subsequently the lower part 24. Likewise, this reinforcement device 26 can for example also be equipped with only one reinforcement element and without these clamping devices 40. Greater or fewer than four such connection points 32, 33 can also be provided, depending on the heavy load.

As is obvious from FIG. 1, the front head part 21 of the reactor 20 is moved inside the supporting structure 15 by the transport means 11, with the reinforcement element 27 of the reinforcement device 26, and the two longitudinal elements 32 of the lifting system 25, designed preferably as strands, are connected to the respective connection point 32 at the reinforcement device 26 in this position, and the reactor 20 is pivoted upwards as heavy load by actuating the lifting system.

The transport means 11 with a top platform 11′ is formed preferably by two transport units 12, 13, which can be moved independently of one another, which together convey the heavy load respectively in part to the supporting structure 15, as illustrated in FIG. 2. These transport units 12, 13 consist of a plurality of axles and wheels, such that the load per wheel corresponds to the predetermined weight load, wherein the axles are respectively driven individually. After connecting the longitudinal elements 32 of the lifting system 25 to the reactor 20 and same being lifted, the front transport unit 12 is removed, whereas the rear transport unit 13, with a tilting rod 45 housed articulated thereto and with this the reactor, moves inside the cavity 18 of the supporting structure 15 and simultaneously the reactor is pivoted upwards in the cavity.

Similarly to a torpedo, the outer shape of the reactor 20, formed with different diameters, adjoins above the platform 11′ of the transport means 11 at several preferably flat points of the tilting rod 45, and when being inserted in horizontal direction, is supported securely on this tilting rod and on the transport means. This box-shaped tilting rod 45 is composed of longitudinally and transversely connected supporting elements 48, 49, this articulated connection 31 and a support element 52 holding the support frame 39 of the reactor 20 at the bottom. Depending on the outer shape of the heavy load, this tilting rod can be designed differently and can consist of several modules.

FIG. 3 shows the lifting system 25 arranged in the supporting structure 15, in which preferably a strand-jack system is used. According to the invention, this lifting system 25 is mounted in the supporting structure 15, the heavy load to be installed is then connected to several longitudinal elements 34 of the lifting system 25 and conveyed upwards in this supporting structure 15 and the heavy load is fixed in the supporting structure, in particular in the operating position.

This rear transport unit 13 of the transport means 11 is moved inside the supporting structure when pivoting the reactor 20 upwards at a controlled speed of travel corresponding to the pivoting speed, in order that the connection point 32 at the reactor, and this at the longitudinal element 34 of the lifting system 25 engaging with same, move approximately vertically upwards in the supporting structure 15 and the reactor is pulled up with a linear pivot movement, with the result that no disruptive oscillations occur whatsoever.

As shown in FIG. 1, the reactor 20 is pivoted upwards as far as a position in which the tilting rod 45 abuts with its underside opposite the articulated connection 31 against at least one stop 43 on the transport unit 13. Then, the two longitudinal elements 34 of the lifting system 25 are articulated to the connection points 33 of the reinforcement device 26 on the other side, in addition to the already connected longitudinal elements 34. The reactor 20 is pivoted upwards into this inclined, and not upright, position so that it does not tip over onto the other side. In principle, however, it can be pivoted upwards into an approximately upright position with the additional longitudinal elements 34 then being attached.

This articulated connection 31, with the transport means and the tilting rod 45, is then loosened from the reactor and dismounted, with the result that it can be pulled up, with the same proportions of force, from the longitudinal elements 34. Further, non-obvious longitudinal elements are provided which are articulated to connection points 38 on the support frame 39 below the hull 23, in order that the reactor 20 can be guided through the lifting system 25 as far as its end position and can be mounted in the supporting structure.

The lifting system 25 mounted at a specific height in the supporting structure 15 is provided with a cavity 44′ for this purpose on the inside, by which the reactor 20 can be raised up to the operating position as heavy load and fixed therein, as is obvious in FIG. 4 in the fully erected system 10. Due to the longitudinal elements 34 of the lifting system 25 to be connected in the centre region of the reactor 20, it is pulled upwards through the cavity 44′ into the lifting system 25 as far as into the operating position over a partial height region.

This lifting system 25 consists of a base frame 44 supported on the supporting structure 15, solid cross-members 46, 47 standing in pairs thereon, and several lifting units 50, 51, in which, respectively, these longitudinal elements 34 are held displaceable in their longitudinal direction. The one lifting unit 50 and the two cross-members 46 or the other lifting unit 51 and the two cross-members 47 are positioned on the base frame 44 such that the longitudinal elements 34, extending therethrough and articulated at the connection points 32, 33 or 38 of the reactor 20, are aligned approximately vertically in order to avoid bending moments in these longitudinal elements produced conventionally as strands.

The two lower cross-members 47 abut against the base frame 44, whereas the two upper cross-members 46 are aligned transverse to the lower ones and abut against the base frame 44 due to spacers 46′ above the lower cross-member 47. These cross-members 46, 47 arranged in pairs are arranged spaced apart from one another. Self-evidently, only one cross-member or more than two can be used, as needed.

These lifting units 50, 51 known per se and not shown in detail consist substantially of a hydraulic or pneumatic piston/cylinder unit fixed on one or the cross-members 46, 47 with, on the inside, a central through-opening for receiving one or more longitudinal elements 34. The cylinder is provided with an annular chamber, in which the sleeve-shaped piston is guided in axial direction. A clamping device is provided with radially adjustable clamps for holding the longitudinal element(s) 34 at the upper end of the piston or at the bottom end of the cylinder respectively. When the pistons are inserted, its clamps hold the longitudinal element 34 in place and a medium is pushed into the cylinder by a pump, with the result that the piston, and with it the longitudinal element, is pushed upwards. Once the piston has been moved out, the open clamps on the cylinder are closed and those on the piston are opened, and the latter is then moved back in again. This sequence is repeated as often as it takes for in particular the heavy load to be lifted to have reached its end position. When lifting the heavy load upwards, these strands are moved outwards and upwards by and over the lifting units 50 and can be received in straight or rounded guides above the lifting system 25, which is not shown in more detail. Operation of the several piston/cylinder units is matched synchronously to one another, and this can take place due to pressure equalisation in order to achieve a uniform load distribution.

It is self-evident that, vice versa, it is also just as possible for the heavy load to be lowered with these lifting units 50, but this is not explained in more detail. Correspondingly, the individual steps have to occur in in the reverse sequence when lowering.

The method of mounting the reactor extends moreover to installing the supporting structure 15 for receiving the heavy load, wherein the supporting structure 15 consists of longitudinal elements and transverse elements 16, 17 which can be assembled one above the other and/or other supporting elements, which supporting structure is built onto a vehicle 59, as illustrated in FIG. 4, by at least one known crane system 55 with several towers 56, 57, 58. Very advantageously, the supporting structure 15 is built to a specific interim height and then the lifting system 25, the base frame 44 of which is recognisable, is mounted onto the approximately half built supporting structure 15. The reactor 20 is then conveyed as heavy load from the lifting system 25 to this interim height and held and mounted in the base frame 44 by its support frame 39. This mounting can take place by sufficiently strong mounting means. Almost simultaneously, the supporting structure 15 is installed up to its overall height by the crane system 55, wherein the heavy load to be conveyed is in particular this reactor 20 for metal extraction in at least approximately operation-ready state.

The reactor 20 raised up to the lifting system 25 in the supporting structure 15 is guided by this frame-shaped lifting system and mounted below the hull 23, preferably up to this interim height, in the supporting structure 15, with support frame 39 attached to its outer cover. The transport means 11 is moved away after lifting the heavy load, and further heavy loads can be supplied to the supporting structure with it. In so doing, at least one supporting element supplied to the supporting structure 15 is attached to a support in the lower region of the heavy load by at least one further longitudinal element 34 of the lifting system 25.

While the supporting structure 15 is finished up to its overall height above the installed heavy load by the crane system 55, further components, such as at least one cooling container 60, supporting elements 62, scaffolding bases 61, etc., can be lifted up and mounted simultaneously in parallel with the lifting system 25 in the lower region or below the reactor, as further heavy loads. Once the reactor has been mounted in the supporting structure 15, transport means for supplying and the same longitudinal elements 34 of the lifting system 25 can likewise be used for this as for lifting the reactor, advantageously over those which are associated with the lifting units 51 at the cross-members 46, because these pass outside the outer sheath of the reactor.

By simultaneously mounting on the lower and upper section of the supporting structure 15, the first platform is used as protective platform 63 in the upper building section. This is reinforced with additional protections in order to protect people working below.

The lifting system 25, mounted temporarily to this specific height in the supporting structure 15 with the cross-members 46, 47, is preferably dismounted again after complete assembly of the heavy load and further components. The supporting structure and the region surrounding same are designed such that this lifting system 25 with cross-members 46, 47 can be used in particular for dismounting the heavy load and the components can be reinstalled in the supporting structure. In principle, however, it could also remain in the supporting structure, in particular if components need to be replaced or examined now and then.

FIG. 5 to FIG. 7 show a lifting device 65 for mounting or dismounting cross-members 46 into or from a supporting structure 70, shown in section. The same reference signs as in the embodiment example according to FIG. 1 to FIG. 4 are used below for the same constituents or components. The reactor 20 installed according to the invention is shown in this supporting structure 70, which structure is held with its support frame 39 in the base frame 40 of the supporting structure 70. The lifting system 25 is supported on the base frame 44, which frame comprises two solid cross-members 46, 47 lying each in pairs, and several lifting units 50, 51 placed upon the latter, in which respectively these longitudinal elements 34, as is obvious from FIG. 3, are held displaceable in longitudinal direction.

The supporting structure 70, shown in part, with the longitudinal, transverse and inclined elements 75, 76, 77, assembled one above the other, is designed in the region of the mounting of the reactor 20 such that the longitudinal elements 75 pass below the base frame 44 inclined upwards and inwards and the quadrangular, or otherwise shaped, section of the supporting structure 70 is reduced from a larger to a smaller cross-sectional surface in order to save material correspondingly in the upper, less heavily loaded, part of the supporting structure 70. The bottom part of the supporting structure is also therefore built with a larger cross-sectional surface in order that sufficient space for moving the reactor 20 upwards is provided when installing in same.

After the reactor 20 has finished being installed, as well as the additional components, in a normal case the lifting units 50, 51 and subsequently the cross-members 46, 47, 66 are dismounted again, because these are no longer needed and can be used for other constructional systems. This lifting device 65, which is assembled from a guide rail 67, crane ropes 68, 69, a mounting means 72 and a counterweight 64 is composed with an adjusting member 71, wherein the mounting means 72 are mounted fixed to one end of the guide rail 67, whereas the counterweight 64 is guided displaceable from the other end as far as a first position 64′ of the guide rail 67, in order for this guide rail 67 always to be balanced out horizontally, whether with or without the cross-member 46, 47, 66 to be conveyed.

The adjusting member 71 consists of a cable pull 71 arranged either side of the guide rail 67, each with a cable winch 72, a rotation motor which can be controlled by same, a cable 73 guided parallel to the guide rail 67 and a holder 78 of the cable end. The two cable pulls are placed in opposite arrangement, in order for the counterweight 64 to be able to be pulled by the respective cable 73 and the cable winch 72 in one or other direction. The cable winches 72 are housed rotatable each at a support 79 on the guide rail 67, whereas the holders 78 are anchored on the counterweight 64 for the cables 73. The counterweight 64 can be adjusted between a first and a second end position 64′, 64″ in controlled manner by the adjusting member 71 on the guide rail 67. In principle, only one cable pull could also be provided, which for example would be provided with a cable winch at either end. Moreover, a braking device interacting with the guide rail is integrated in the counterweight, which device is not shown in more detail and serves to ensure the counterweight can be fixed additionally in a respective end position.

This lifting device 65 is illustrated in addition to the supporting structure 70 in FIG. 5, which structure is lifted upwards by a crane of the supporting structure 70, not shown in more detail, in addition to the lifting system 25, in order to dismount these cross-members 46, 47, 66. In the unloaded state, as shown, the counterweight is pushed into this first position 64′ by the adjusting member 71, with the result that the guide rail 67 provided with the lateral mounting means 72, preferably suspended on two crane ropes 68, is balanced horizontally.

As illustrated in FIG. 6 and FIG. 7, a cross-member 46 is for example screwed laterally onto the mounting means 72 and then guided transversely out of the supporting structure 70 and placed below, for example on a motor vehicle to be transported away. This process is then repeated until advantageously all cross-members 46, 47, 66 have been dismounted, including those which are fixed below the base frame 44 in corners of the transverse element 76. With this lifting device 65 being suspended on the crane rope 69, for reasons of space it can be inserted into the open inside of the supporting structure 70 only with one part of its guide rail 67 and then be connected to a respective cross-member 46, 47, 66 by this lateral mounting and pull or lift this out of the supporting structure.

The invention is sufficiently displayed with the exemplary embodiments described above. However, it could self-evidently still be explained by further variants.

As a variant, the lifting system could be equipped with a different number of lifting units 50, 51 and longitudinal elements 34 from that shown, and the cross-members 46, 47 could be arranged other than shown. Thus, the lifting system could consist of only one frame or a structure similar to a frame or of supporting elements such as the supporting structure and be firmly integrated into the latter. Likewise, the base frame could be provided not as completely in the supporting structure but only as several frame parts or similar.

Hoists, driven pulleys, climbing cranes and/or similar can be used as lifting systems.

Likewise, the supporting structure could for example be arranged in a building, and primarily be formed from pillars or the like.

Instead of an SPMT, another feed system, such as one sliding on plastic or a vehicle travelling on rails or the like, could also be used as transport means 11.

1. A method for installing a heavy load in a supporting structure, in which the supporting structure (15) consists of supporting elements which can preferably be assembled one above the other and is assembled at least by a crane system (55), characterized in that a lifting system (25), preferably a strand jack system, is mounted in the supporting structure (15), the heavy load to be installed is then connected to several longitudinal elements (34) of the lifting system (25) and conveyed upwards in this supporting structure (15) and the heavy load is fixed in the supporting structure, in particular in the operating position.

2. Method according to claim 1, characterized in that the lifting system (25), mounted at a certain height in the supporting structure (15), is provided with a cavity (44′) on the inside through which the heavy load can be lifted in the supporting structure, up to the operating position and fixed there.

3. Method according to claim 1, wherein the heavy load, which can be pivoted upwards from a horizontal position by the longitudinal elements (34) of the lifting system (25), articulated to same at the top, is consequently pulled up by longitudinal elements (34) of the lifting system (25) which are, or are to be, connected in the central region of the heavy load, over a partial height range through the cavity of the lifting system up as far as into the operating position.

4. Method according to claim 1, the heavy load to be conveyed is a reactor (20) for metal extraction in at least approximately operation-ready finished state.

5. Method according to claim 1, wherein the lifting system (25) is mounted in the supporting structure (15) such that it can be removed from this supporting structure after the system (10) has finished being installed, and can be re-installed therein when the heavy load has to be dismounted from the supporting structure and/or replaced.

6. Method according to claim 5, characterized in that the lifting system (25) has cross-members (46, 47) mounted in the supporting structure (15) and attached to these lifting units (50, 51), wherein these cross-members (46, 47) and lifting units (50, 51) can be removed after the system (10) has finished being installed, in which the cross-members (46, 47) can be conveyed laterally away from the supporting structure (15) or correspondingly laterally inserted and fixed therein after being re-installed.

7. Method according to claim 6, characterized in that a lifting device (65) for mounting or dismounting cross-members (46, 47, 66) of the lifting system (25) is used in or by the supporting structure (15, 70) such that this lifting device (65) is raised with a cross-member (46, 47, 66) mounted on same by means of a crane adjacent to the lifting system (25) of the supporting structure (15, 70) and this cross-member is inserted and mounted laterally in the supporting structure (15, 70), whereas, during dismounting, the raised lifting device (65) is connected respectively to a cross-member (46, 47, 66) and the latter is conveyed away from same laterally out of the supporting structure (15, 70), and that this is repeated until all cross-members (46, 47, 66) are mounted or dismounted.

8. System with a supporting construction and at least one heavy load held therein, wherein the system has been built according to the method of claim 1, wherein the supporting structure (15) is provided with supporting elements assembled one above the other supporting elements and the heavy load (20) can be mounted therein, wherein the lifting system (25) has lifting units (50, 51) arranged in the supporting structure (15), in which respectively longitudinal elements (34) are held displaceable in longitudinal direction, which longitudinal elements extend through the supporting structure (15) and can be connected to the heavy load (20) to be mounted.

9. System according to claim 8, characterized in that the lifting system (25) is provided with a base frame (44) forming a cavity (44′) supported in the supporting structure (15), with cross-members (46, 47) held thereon and the several lifting units (50, 51) attached thereto, in which the longitudinal elements (34) respectively extend through a cross-member (46, 47) and the base frame (44).

10. System according to claim 9, characterized in that cross-members (46, 47) are arranged, in pairs on the inside of the supporting structure (15) and the lifting units (50) thereon, on the base frame (44), and the lifting units (50) are attached to the cross members, positioned such that the longitudinal elements (34) extending through same and capable of being articulated to the connection points (32, 33, 38) of the reactor (20) are aligned approximately vertically in the lifting state, in order to prevent bending moments in these longitudinal elements (34) conventionally produced as strands.

11. System according to claim 9, wherein two lower cross-members (47) adjoin the base frame (44) and two upper cross-members (46) aligned transverse to these lower ones are held above the lower cross-members (47) on the base frame (44) by spacers (46′), wherein this pair of cross-members (46, 47) is arranged at a distance from one another.

12. System according to claim 8, wherein longitudinal elements (34) of the lifting system (25) can be connected at connection points (38) on the support frame (39) below the hull (23) in its central region at the reactor (20), in order that the reactor (20) can be guided through up to its end position and mounted in the supporting structure by the lifting system (25).

13. System according to claim 12, characterized in that the reactor (20) can be guided into the base frame (44) far enough for it to be able to be fixed below the hull (23) in the base frame in the supporting structure (15) with its support frame (39).

14. System according to claim 13, characterized in that the connection points (38) are placed below on the support frame (39) of the reactor (20), which points can be connected to the longitudinal elements (34) of the lifting units (51) at the upper cross-members (46) of the lifting system (25), in order that the support frame (39) of the reactor (20) can be lifted as far as the base frame and fixed therein.

15. System according to claim 8, wherein the lifting units (50, 51) are provided respectively with a hydraulic or pneumatic piston/cylinder unit and at the upper end of the piston or at the lower end of the cylinder respectively with a clamping device with radially adjustable clamps for alternately holding or releasing the longitudinal element(s) (34), which element(s) is (are) guided through inside a central through opening of the piston/cylinder unit.

16. System according to claim 8, wherein the lifting device (65) is assembled from a guide rail (67), a mounting means (72) and a counterweight (64) with an adjustment member (71), wherein the guide rail (67) with the mounting means (72) on the end face can be connected laterally to the respective cross-member (46, 47, 66) and, after connection, the latter can be conveyed laterally in or out of the support structure, during mounting or dismounting.
